(19) United States
(12) Patent Application Publication
(10) Pub. No.: US 2016/0086568 A1
(43) Pub. Date: Mar. 24, 2016

(54) Display Device, Control Method For The Same, And Storage Medium Having Control Program Stored Thereon

(71) Applicant: CASIO COMPUTER CO., LTD., Shibuya-ku (JP)

(72) Inventors: Keiichi IMAMURA, Hamura-shi (JP); Hiroshi HIGASHIYAMA, Hachioji-shi (JP); Tsuyoshi MINAMI, Musashimurayama-shi (JP); Kimiyasu MIZUNO, Akishima-shi (JP); Takashi SUENAGA, Setagaya-ku (JP)

(73) Assignee: CASIO COMPUTER CO., LTD., Tokyo (JP)

(21) Appl. No.: 14/839,482

(22) Filed: Aug. 28, 2015

(30) Foreign Application Priority Data
Sep. 22, 2014 (JP) 2014-192405

(51) Int. Cl. G09G 5/00; G06F 3/00

(52) U.S. Cl. CPC G09G 5/006; G06F 3/002; G09G 2340/12; G09G 2360/06; G09G 2310/0237

(57) ABSTRACT

A display device including a first display panel having a first display area, a second display panel having a second display area, an arithmetic circuit which controls a display status of the first display panel and a display status of the second display panel, and a sensor which detects a spatial movement of the display device, in which the arithmetic circuit changes a display mode of images displayed by the first display panel and the second display panel based on a detection result by the sensor.

### CROSS-REFERENCE TO RELATED APPLICATION

This application is based upon and claims the benefit of priority from the prior Japanese Patent Application No. 2014-192405, filed Sep. 22, 2014, the entire contents of which are incorporated herein by reference.

### BACKGROUND OF THE INVENTION

1. Field of the Invention

The present invention relates to a mountable or portable electronic device that is worn on the body of a user. Specifically, the present invention relates to a display device for displaying various information, and a control method and a control program for the display device.

2. Description of the Related Art

In recent years, various products to be worn on the human body have been developed and available on the market for recording and analyzing various data at the time of exercise such as running, cycling, swimming, or trekking or in daily lives. Also, portable electronic devices such as portable telephones, smartphones (multifunctional portable telephones), and tablet terminals have also been widely available. These electronic devices include a display device for providing various information to its user.

For example, Japanese Patent Application Laid-Open (Kokai) Publication No. 2013-220176 discloses a so-called sports watch that is worn on the body of a user for providing the user with exercise data and the like collected at the time of exercise and analyzed, by displaying the data on a display device.

### SUMMARY OF THE INVENTION

In accordance with one aspect of the present invention, there is provided a display device comprising: a first display panel having a first display area; a second display panel having a second display area; an arithmetic circuit which controls a display status of the first display panel and a display status of the second display panel; and a sensor which detects a spatial movement of the display device, wherein the arithmetic circuit changes a display mode of images displayed by the first display panel and the second display panel based on a detection result by the sensor.

In accordance with another aspect of the present invention, there is provided a display device control method comprising: a step of displaying, on a display section including a first display panel having a first display area and a second display panel having a second display area arranged to be at least partially overlapped with the first display area when viewed from a view field side of a user, a display image acquired by a display status of the first display panel being combined with a display status of the second display panel; a step of detecting a spatial movement of the first display panel and the second display panel; and a step of changing a display mode of the image displayed by the first display panel and the second display panel based on a result of the detection.

In accordance with another aspect of the present invention, there is provided a non-transitory computer-readable storage medium having a display device control program stored thereon that is executable by a computer to actualize functions comprising: processing for displaying, on a display section including a first display panel having a first display area and a second display panel having a second display area arranged to be at least partially overlapped with the first display area when viewed from a view field side of a user, a display image acquired by a display status of the first display panel being combined with a display status of the second display panel; processing for detecting a spatial movement of the first display panel and the second display panel; and processing for changing a display mode of the image displayed by the first display panel and the second display panel based on a result of the detection.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1A is a schematic structural perspective view of a specific example of an embodiment of an electronic device including a display device according to the present invention;

FIG. 1B is a schematic structural perspective view of another specific example of the embodiment of the electronic device including the display device according to the present invention;

FIG. 1C is a schematic structural perspective view of still another specific example of the embodiment of the electronic device including the display device according to the present invention;

FIG. 1D is a schematic perspective view of an example of the structure of a display device applied in the electronic device according to the embodiment;

FIG. 2 is a block diagram depicting a schematic structure of the electronic device according to the embodiment;

FIG. 3 is a block diagram depicting a schematic structure of the display device applied in the electronic device according to the embodiment;

FIG. 4 is a schematic diagram showing an example of a first display mode of screen display by the electronic device according to the embodiment;

FIG. 5A is a first schematic diagram showing an example of a second display mode of screen display by the electronic device according to the embodiment;

FIG. 5B is also a first schematic diagram showing an example of the second display mode of screen display by the electronic device according to the embodiment;

FIG. 6A is a second schematic diagram showing an example of the second display mode of screen display in the electronic device according to the embodiment;

FIG. 6B is also a second schematic diagram showing an example of the second display mode of screen display in the electronic device according to the embodiment;

FIG. 6C is also a second schematic diagram showing an example of the second display mode of screen display in the electronic device according to the embodiment;

FIG. 7A is a first schematic diagram showing an example of a third display mode of screen display in the electronic device according to the embodiment;

FIG. 7B is also a first schematic diagram showing an example of the third display mode of screen display in the electronic device according to the embodiment;

FIG. 8A is a second schematic diagram showing an example of the third display mode of screen display in the electronic device according to the embodiment;

FIG. 8B is also a second schematic diagram showing an example of the third display mode of screen display in the electronic device according to the embodiment;

FIG. 8C is also a second schematic diagram showing an example of the third display mode of screen display in the electronic device according to the embodiment;

FIG. 9 is a flowchart of an example of an electronic device control method according to the embodiment; and

FIG. 10A to FIG. 10D are schematic diagrams showing an example of a method for detecting a user's visual recognition motion in the electronic device control method according to the embodiment.

### DETAILED DESCRIPTION OF THE PREFERRED EMBODIMENTS

Hereafter, embodiments of a display device, an electronic device including the display device, and a control method and a control program therefor are described in detail.

<Display Device and Electronic Device>

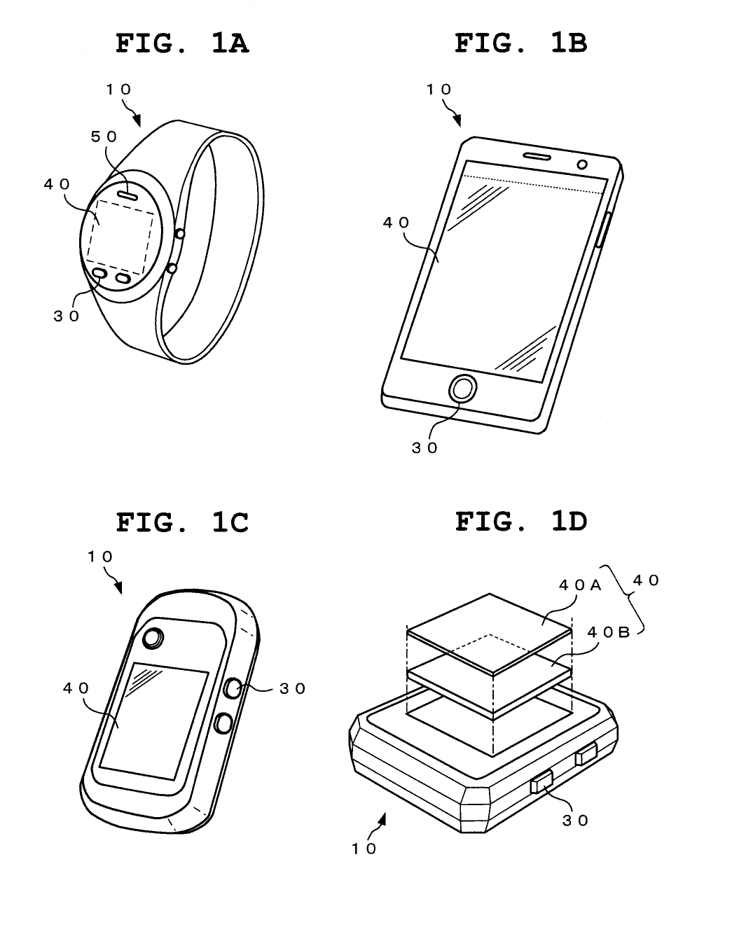

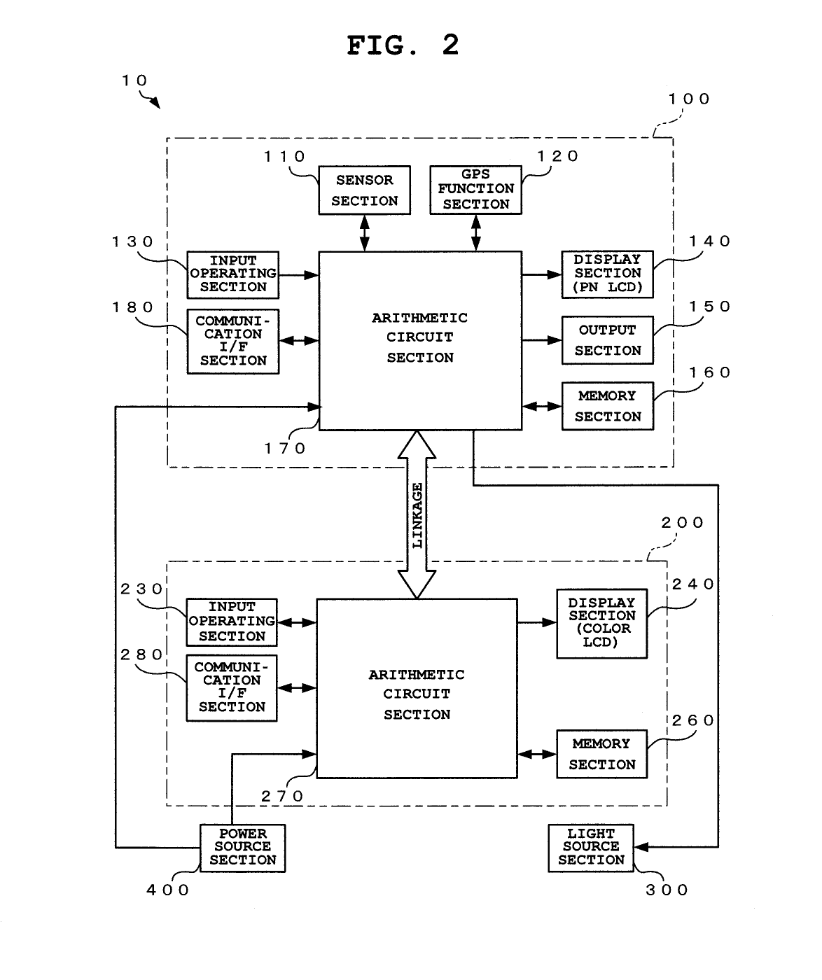

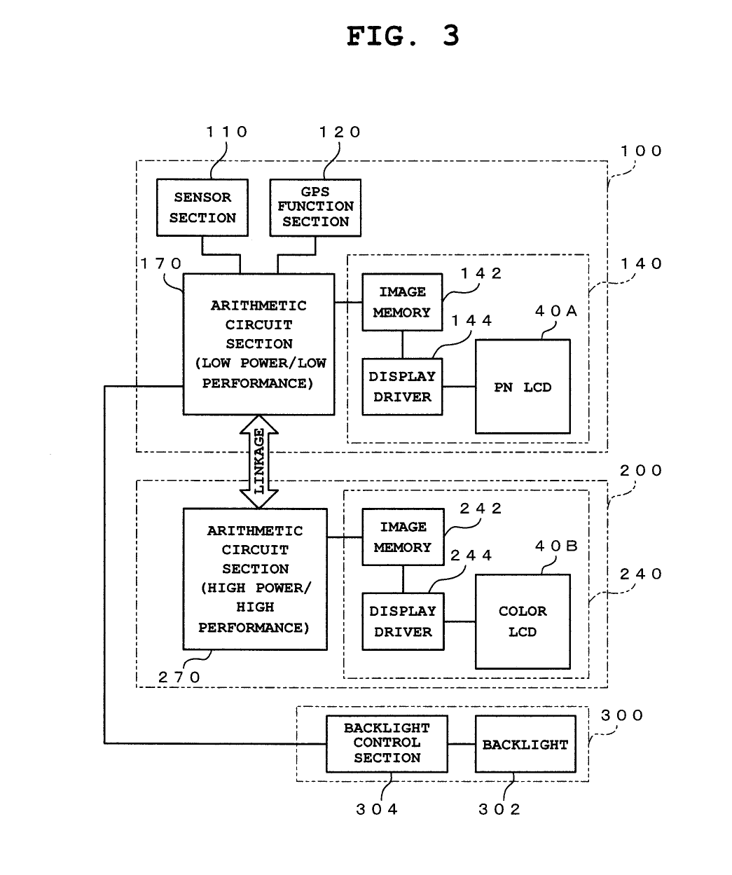

FIG. 1A to FIG. 1D are schematic structural views of an embodiment of the electronic device including the display device according to the present invention. Specifically, FIG. 1A to FIG. 1C are schematic perspective views of a plurality of specific examples of the electronic device according to the embodiment, and FIG. 1D is a schematic perspective view of an example of the structure of a display device applied in the electronic device according to the present embodiment. FIG. 2 is a block diagram depicting a schematic structure of the electronic device according to the present embodiment, and FIG. 3 is a block diagram depicting a schematic structure of the display device applied in the electronic device according to the present embodiment.

The electronic device 10 including the display device according to the embodiment of the present invention is structured to have, for example, a display panel 40 for displaying at least various information, as depicted in FIG. 1A to FIG. 1C. This electronic device 10 may have an outer appearance of a wristwatch type or wristband type. For example, the electronic device 10 may be a sports watch or a smartwatch that is worn on the body of a user, as depicted in FIG. 1A. Also, the electronic device 10 may be a smartphone or portable telephone that is used by being held by the user's hand, as depicted in FIG. 1B. Moreover, the electronic device 20 may be a portable device (for example, a GPS (Global Positioning System) logger) that is used outdoors in mountaineering or the like by being held by the user's hand, as depicted in FIG. 1C.

In FIG. 1A to FIG. 1C, reference numeral 30 denotes an input operating section such as a button switch or touch panel, and reference numeral 50 denotes an output section such as a loudspeaker or buzzer. The structure of the electronic device 10 including the display panel 40, the input operating section 30, and the output section 50 will be described later in detail.

In this electronic device 10, the display panel 40 includes, for example, a display panel 40A and a display panel 40B as depicted in FIG. 1D, and have a structure where the display area of the display panel 40A and the display area of the display panel 40B have been superimposed (overlapped) on each other.

Here, the display panel (first display panel) 40A arranged on the user's view field side (an upper layer side in the drawing) has a characteristic of singly displaying character information, image information, and the like in a reflective manner so that they are visually recognized favorably. Also, the display panel 40A has a characteristic by which the current state is changed to at least a transparent or translucent state so that the character information, image information, and the like displayed on the display panel 40B arranged on the back surface side (the side opposite to the view field side; a lower layer side in the drawing) pass through to the view field side and are visually recognized by the user favorably.

As the display panel 40A in the present embodiment, for example, a PN (Polymer Network; high-polymer dispersion) liquid-crystal panel can be favorably adopted which is capable of monochrome display in a reflective manner with excellent outdoor visual recognition and relatively high reflectivity and also capable of semi-transparent display or full-transparent display.

The PN liquid-crystal panel has the following characteristics. That is, by an electric field being formed in a direction perpendicular to a panel flat surface, the PN liquid crystal panel enters a state where polymers in a liquid-crystal layer are aligned in an electric field direction so that light passes therethrough. On the other hand, in a state where polymers are dispersedly arranged without forming an electric field, the PN liquid-crystal panel enters a non-transparent state with irregular reflection or dispersed irregular reflection of light, thereby allowing character information, image information, and the like to be displayed in a reflective manner.

As a result, by combining a predetermined segment and graphic to acquire non-transparency and achieve irregular reflection or dispersed irregular reflection of external light, the PN liquid-crystal panel can display character information and image information as a simple monochrome image (or monotone image). Also, since the PN liquid-crystal panel has a characteristic of not requiring electric power to keep its display status, the PN liquid-crystal panel can generally be driven for display with low power consumption. Note that, although the display panel 40 described above has two display panels (the display panel 40A and the display panel 40B), the number of display panels included in the display panel 40 may be more than two.

On the other hand, the display panel (second display panel) 40B arranged on the opposite side to the user's view field side (back surface side of the display panel 40A) has a characteristic of singly displaying character information, image information, and the like with excellent color representation and visual effects with high definition. Also, the display panel 40B is structured to include a light source (such as a backlight) so as to allow displayed character information, image information, and the like pass through the display panel 40A to be visually recognized by the user favorably.

As the display panel 40B in the present embodiment, for example, a transmission-type TFT (Thin Film Transistor) color liquid-crystal panel that is capable of color display in high definition and excellent (rich) in color representation and visual effects can be favorably adopted. The TFT color liquid-crystal panel generally has a feature by which character information and image information can be displayed with rich color representation and high visual recognition by light from the light source (backlight)) arranged on the back surface side (lower layer side) passing therethrough. However, normally, power consumption is large as compared to the display panel 40A in which the above-described PN liquid-crystal panel has been applied.

The electronic device 10 according to the present embodiment specifically includes, for example, an internal circuit 100 including the display panel 40A in which the above-described PN liquid-crystal panel has been applied, an internal circuit 200 including the display panel 40B in which the above-described TFT color liquid-crystal panel has been applied, a light-source section 300, and a power supply section 400, as depicted in FIG. 2. Here, a case is described in which the electronic device 10 according to the present embodiment has been applied as a device that is worn on a body to collect and analyze various data at the time of exercise and various daily data, such as a wristwatch-type sports watch to be worn on a wrist (refer to FIG. 1A).

The internal circuit 100 mainly includes, for example, a sensor section (detecting section) 110, a GPS function section 120, an input operating section (detecting section) 130, a display section 140, an output section 150, a memory section 160, an arithmetic circuit section (first arithmetic circuit section) 170, and a communication interface section (hereinafter referred to as a “communication I/F section”) 180, as depicted in FIG. 2.

The sensor section 110, which is sensor means such as an acceleration sensor, gyro sensor, geomagnetic sensor, atmospheric pressure sensor, temperature-humidity sensor, pulse sensor, and heart rate sensor, acquires various physical or biological data (sensor data) during exercise and daily life of the user and outputs it to the arithmetic circuit section 170. Here, the sensors such as an acceleration sensor, gyro sensor, and geomagnetic sensor perform sensing operations during the user's exercise at 100 or more cycles per second (a sampling frequency equal to or more than 100 Hz), and outputs sensor data to the arithmetic circuit section 170.

The GPS function section 120 includes a GPS antenna and a GPS receiving section. By receiving electric waves from a plurality of GPS satellites via the GPS antenna, the GPS receiving section acquires geographic positional information and outputs the information as positioning data to the arithmetic circuit section 170. As a result, in the arithmetic circuit section 170, for example, a current position and travelling route of the user having the electronic device 10 worn thereon are calculated. Here, the GPS function section 120 performs a sensing operation in, for example, one cycle per one to several seconds, and outputs positioning data to the arithmetic circuit section 170.

The input operating section 130 is, for example, input means such as a button switch, slide switch, or microphone, provided on the housing of the electronic device 10, and outputs various operation signals generated by the user's input operation to the arithmetic circuit section 170. As a result, the arithmetic circuit section 170 performs settings and control of the above-described sensing operations in the sensor section 110 and the GPS function section 120; and selection, settings, and the like of items, character information and image information to be displayed on the display section 140 and a display section 240, which will be described further below.

The display section 140 includes the above-described display panel 40A in which the PN liquid-crystal panel has been applied, an image memory (frame memory) 142, and a display driver (LCD driver) 144, displaying various information generated in the arithmetic circuit section 170 in a predetermined form.

Here, in the present embodiment, by using the characteristics of the PN liquid-crystal panel, the display panel 40A is controlled by the arithmetic circuit section 170 in a semi-transparent state (a state of having a non-transparent portion or region) or a full-transparent state. That is, when the display panel 40A is in a semi-transparent state, irregular reflection or dispersed irregular reflection of light occurs only in an area corresponding to a specific segment, graphic, and the like, and this area is visually recognized as white display, whereby reflective-type display is achieved. In other areas, an image displayed on the displayer panel 40B as a lower layer passes through to be visually recognized. On the other hand, when the display panel 40A is in a full-transparent state, the entire display area of the display panel 40A is in a transparent state, no display is performed in the entire display area, and the image displayed on the display panel 40B as the lower layer substantially entirely passes through to be visually recognized.

As a result, the display section 140 is controlled by the arithmetic circuit section 170 to mainly be in a form of singly displaying, in monochrome, various information generated in the arithmetic circuit section 170 in a semi-transparent state with a segment, graphic, and the like; a form of displaying, in monochrome, in a semi-transparent state with a segment, graphic, and the like by being linked with character information, image information, and the like displayed on the display section 240 of the internal circuit 200 described later; and a form of setting the display panel 40A in a full-transparent state and displaying nothing in the entire area. Note that examples of display of the character information, image information, and the like on the display section 140 and the display section 240 of the internal circuit 200 will be described in detail further below in display modes.

The output section 150, which is acoustic means such as a buzzer or loudspeaker, or vibration means such as a vibration motor or vibrator, generates sound information such as a predetermined tone color, sound pattern, or audio message, or vibration information such as a predetermined vibration pattern or its intensity, and thereby aurally or tactually provides or informs the user with or of various information. Here, the output section 150 may generate predetermined sound information or vibration information in association with character information, image information, and the like displayed on the above-described display section 140 or the display section 240 of the internal circuit 200.

The memory section 160 stores sensor data acquired by the sensor section 110 and positioning data acquired by the GPS function section 120 in a predetermined storage area. Also, the memory section 160 stores data for use and generated in executing a predetermined control program and algorithm program by the arithmetic circuit section 170, data for display on the display section 140, and the like. Furthermore, the memory section 160 may store a control program and an algorithm program to be executed by the arithmetic circuit section 170. Note that an entire or part of the memory section 160 may be partially or entirely in a form of a removable storage medium such as a memory card, and may be structured to be removable from the electronic device 10.

The arithmetic circuit section 170 is an arithmetic operation device such as a CPU (Central Processing Unit) or MPU (Micro Processor). By executing a predetermined control program or algorithm program, the arithmetic circuit section 170 controls various operations such as a sensing operation by the sensor section 110 and the GPS function section 120, provision of various information by the display section 140 and the output section 150, and transmission and reception of various data by the communication I/F section 180. In particular, the arithmetic circuit section 170 controls the transmission status (each of the non-transparent, semi-transparent, and full-transparent states) of the display panel 40A in the display section 140 described above, and also controls the display mode of various information in the display section 140 by being linked and synchronized with an arithmetic circuit section 270 of the internal circuit 200.

In the present embodiment, the arithmetic circuit section 170 is only required to have a processing power that enables the control of the display section 140 (the display panel 40A) that is driven for display with low power consumption, the sensor section 110 and the GPS function section 120 which periodically perform a sensing operation, the communication I/F section 180 which transmits and receives data with low power consumption, and the like.

That is, as the arithmetic circuit section 170, it is possible to adopt an arithmetic circuit with an operation clock slower than the operation clock of the arithmetic circuit section 270 of the internal circuit 200 and with relatively low processing performance. This arithmetic circuit can generally save power consumption to a relatively low level.

That is, as the arithmetic circuit section 170, it is possible to adopt an arithmetic circuit with a relatively low processing power and low power consumption (a low-power, low-performance processor).

Here, the control program and the algorithm program to be executed by the arithmetic circuit section 170 may be stored in the above-described memory section 160 or may be incorporated in advance in the arithmetic circuit section 170. Note that a method for controlling the electronic device 10 according to the present embodiment will be described later.

The communication I/F section 180 includes a transmission circuit and a reception circuit, and transmits and receives various data by using a predetermined communication method between the wristwatch-type electronic device 10 according to the present embodiment worn on a wrist and an external electronic device (hereinafter referred to as an “external device” for convenience and omitted in the drawings). Here, the external device for communication via the communication I/F section 180 is, for example, a sensor device (omitted in the drawings) including various sensors, and worn on another body part of the user such as the chest or hip. For example, the electronic device 10 continually receives sensor data and the like collected by the external device at predetermined intervals or timings via the communication I/F section 180, and transfers the data to the arithmetic circuit section 170 and the memory section 160.

Note that, when the communication I/F section 180 is to transmit or receive data to and from the external device via wireless communication, a wireless communication method with low power consumption is used, such as Bluetooth (registered trademark) Low Energy (BLE) communication. Also, the communication I/F section 180 may transmit and receive data with the external device via wired communication. In this case, for example, a wired communication method such as USE (Universal Serial Bus) standards is used.

The internal circuit 200 mainly includes, for example, an input operating section 230, the display section 240, a memory section 260, the arithmetic circuit section 270, and a communication I/F section 280, as depicted in FIG. 2.

The input operating section 230 is input means such as a touch panel arranged on the view field side of the display panel 40A provided to the display section 140 of the internal circuit 100 described above, and outputs various operation signals generated by the user's input operation to the arithmetic circuit section 270. As a result, the arithmetic circuit section 270 performs selection, settings, and the like of items, character information, and image information to be displayed on the above-described display section 140 and the display section 240.

The display section 240 includes the above-described display panel 40B in which the TFT color liquid-crystal panel has been applied, an image memory 242, and a display driver 244 as depicted in FIG. 3, and displays various information generated in the arithmetic circuit section 270 in a predetermined form.

Here, in the present embodiment, by using the characteristics of the transmission-type TFT color liquid-crystal panel, a light source (backlight) provided on the back surface side (the side opposite to the view field side) is switched ON with a predetermined color image being displayed on the display panel 40B, whereby the color image is visually recognized by the user via the display panel 40A.

In particular, in the present embodiment, a color image displayed on the display panel 40B is controlled by the arithmetic circuit section 270 by being linked with the transparent state (any of the semi-transparent state and the full-transparent state) of the display panel 40A provided to the display section 140 of the internal circuit 100 described above and an image displayed on the display panel 40A. As a result, the display section 240 is controlled by the arithmetic circuit section 270 to mainly be in a form of singly displaying, in color, various information generated by the arithmetic circuit section 270; a form of displaying in color by being linked with character information, image information, and the like displayed on the display panel 40A of the internal circuit 100 in monochrome by a segment, graphic, and the like; and a form of not performing display in the entire area of the display panel 40B and functioning as a non-reflective layer (a layer having a characteristic of hardly reflecting light) with respect to the display panel 40A arranged on the view field side.

The memory section 260 has stored therein data for use and generated in executing a predetermined control program and algorithm program by the arithmetic circuit section 270, data for display on the display section 240, and the like. Also, the memory section 260 may have stored therein a control program and algorithm program to be executed by the arithmetic circuit section 270. Note that the memory section 260 may be integrally structured with the memory section 160 provided to the internal circuit 100 described above.

As with the arithmetic circuit section 170 of the internal circuit 100 described above, the arithmetic circuit section 270 is an arithmetic operation device such as a CPU or MPU. By executing a predetermined control program or algorithm program, the arithmetic circuit section 270 controls various operations such as display of various information on the display section 240 and transmission and reception of various data by the communication I/F section 280, which will be described further below. In particular, the arithmetic circuit section 270 controls the display mode of various information on the display section 240 by being linked and synchronized with the arithmetic circuit section 170 of the internal circuit 100 described above.

In the present embodiment, the arithmetic circuit section 270 has a processing power that enables the control of the display section 240 (the display panel 40B) capable of multiple color display with relatively high power consumption, the communication I/F section 280 which transmits and receives various data with relatively large capacity at high speed, and the like.

That is, as the arithmetic circuit section 270, an arithmetic circuit with an operation clock higher than the operation clock of the arithmetic circuit section 170 of the internal circuit 100 and relatively high processing performance is applied. This arithmetic circuit generally tends to have relatively high power consumption. That is, as the arithmetic circuit section 270, it is required to apply an arithmetic circuit with a relatively high processing power and high power consumption (a high-power, high-performance processor).

That is, the arithmetic circuit section 270 has an operation frequency higher than the operation frequency of the arithmetic circuit section 170, a processing power higher than that of the arithmetic circuit section 170, and power consumption higher than that of the arithmetic circuit section 170. Here, the control program and the algorithm program to be executed by the arithmetic circuit section 270 may be stored in the above-described memory section 260 or may be incorporated in advance in the arithmetic circuit section 270.

The communication I/F section 280 includes a transmission circuit and a reception circuit, and transmits and receives various data between the electronic device 10 according to the present embodiment and an external device by using a predetermined communication method. Here, the external device for communication via the communication I/F section 280 is a highly-functional information processing device (omitted in the drawings) such as a smartphone or personal computer. The electronic device 10 transmits relatively large-volume data to the external device via the communication I/F section 280 at high speed. Specifically, for example, the communication I/F section 280 transmits sensor data and the like collected by the electronic device 10 to the external device and receives various information transmitted from the external device. Note that, when the communication I/F section 280 transmitting and receiving data to and from the external device via wireless communication, a wireless communication method such as Bluetooth (registered trademark) communication and Wi-Fi (wireless fidelity (registered trademark)) communication is used. However, the communication I/F section 280 may transmit and receive data to and from the external device at high speed via wired communication. In this case, for example, a wired communication method meeting high-speed communication standards in USB standards is applied.

The light source section 300 includes a backlight 302 and a backlight control section 304, as depicted in FIG. 3. The ON (light on)/OFF (light off) state of this backlight 302 is controlled in accordance with the display status of the display panel 40B provided to the display section 240 of the internal circuit 200 or the display panel 40A provided to the display section 140 of the internal circuit 100.

The backlight 302 is arranged on the back surface side of the display panel 40B. For example, a surface light source using a plurality of LEDs (Light-Emitting Diodes) and various optical members such as a light-guide plate and a light diffusion film is adopted as this backlight 302. The backlight control section 304 controls the ON/OFF state of the backlight 302 based on at least a control signal from the arithmetic circuit section 170 of the internal circuit 100, as depicted in FIG. 2 and FIG. 3. Note that the backlight control section 304 may control the ON/OFF state of the backlight 302 based on, in addition to a control signal from the arithmetic circuit section 170, a control signal from the arithmetic circuit section 270 of the internal circuit 200.

The power supply section 400 generates and outputs predetermined drive power to each structure of the internal circuits 100, 200, and the light source section 300 described above. Here, as the power supply section 400, for example, a primary battery such as a commercially-available coin-shaped battery or button-shaped battery, or a secondary battery such as a lithium-ion battery or a nickel-hydride battery can be adopted. In addition to the above-described primary battery and secondary battery, a power supply by energy harvest technology for generating electricity by energy such as vibrations, light, heat, electro-magnetic waves, or the like can be used as the power supply section 400 singly or in combination.

As described above, the electronic device 10 according to the present embodiment is structured to include the display panel 40A capable of simple monochrome display of a reflective type with excellent outdoor visual recognition and relatively high reflectivity and also capable of semi-transparent display and full-transparent display and the display panel 40B capable of high-definition color display with excellent color representation and visual effects, which are superimposed on each other such that they are overlapped with each when viewed from the view field side.

These display panels 40A and 40B are controlled by the arithmetic circuit sections 170 and 270, respectively, which are independent from each other and have processing powers according to their display modes. By these arithmetic circuit sections 170 and 270 operating in conjunction with each other, various display modes in the display panel 40 are controlled while saving power consumption in the electronic device 10.

<Display Modes>

Next, display modes of screen display by the electronic device according to the present embodiment are described.

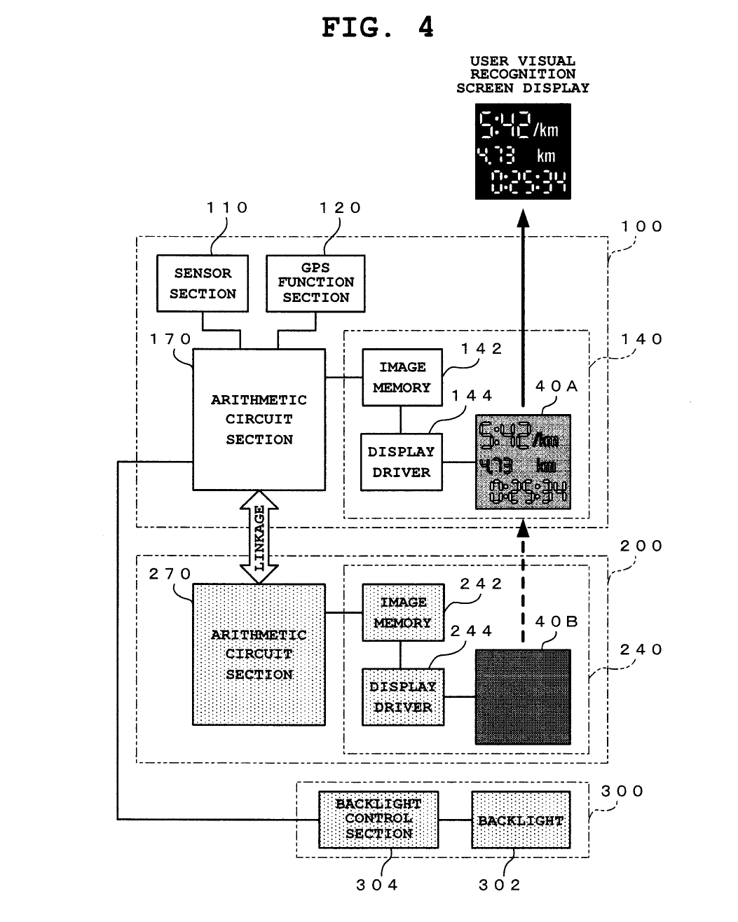

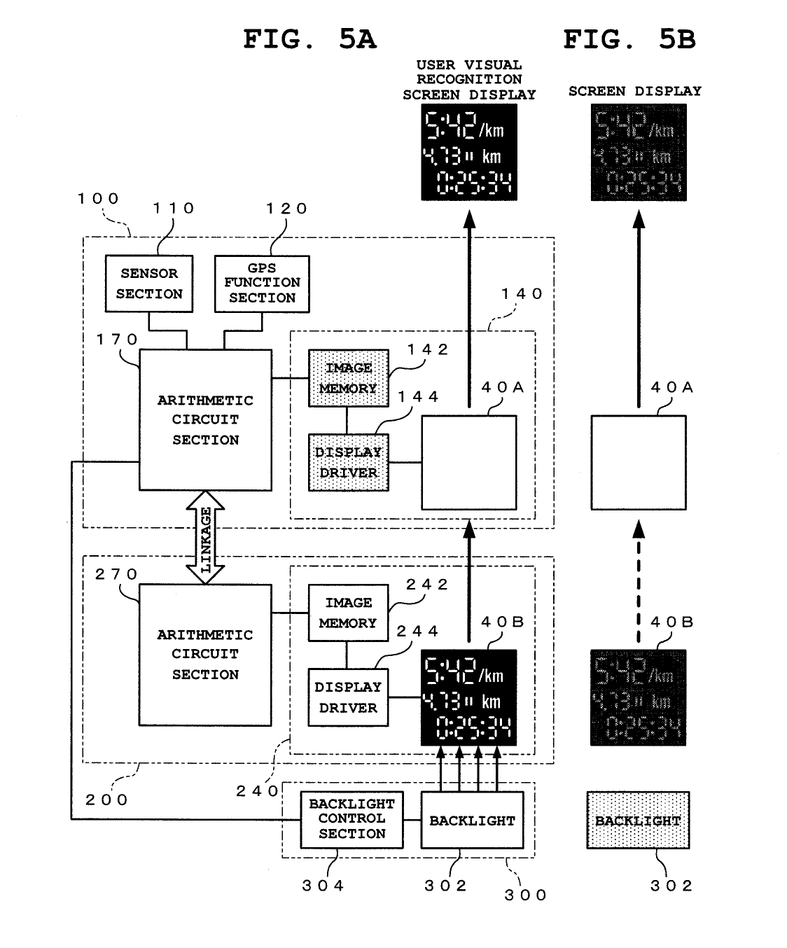

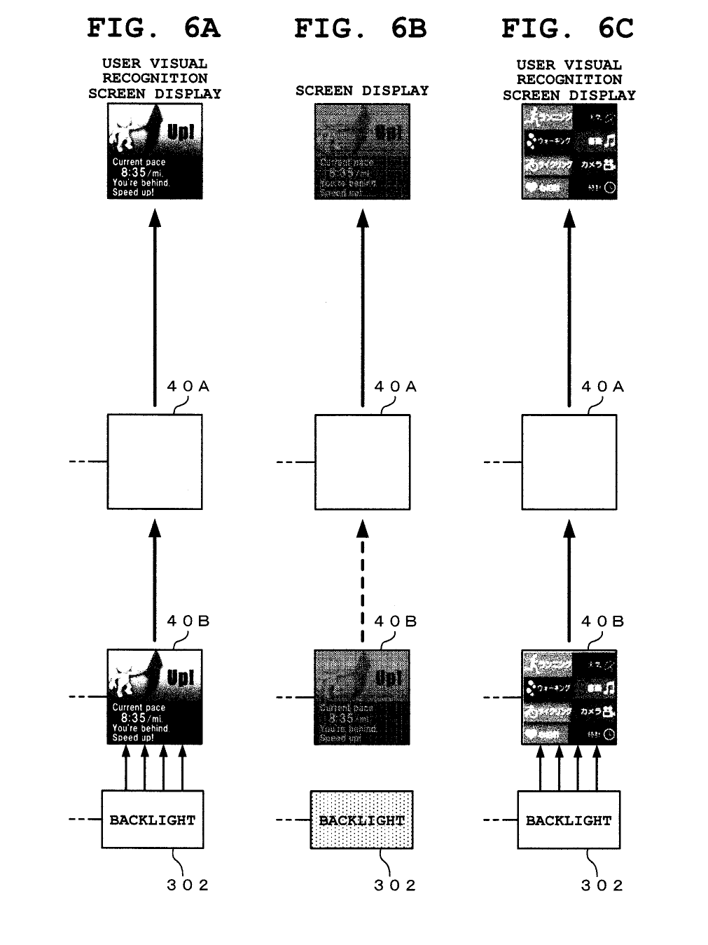

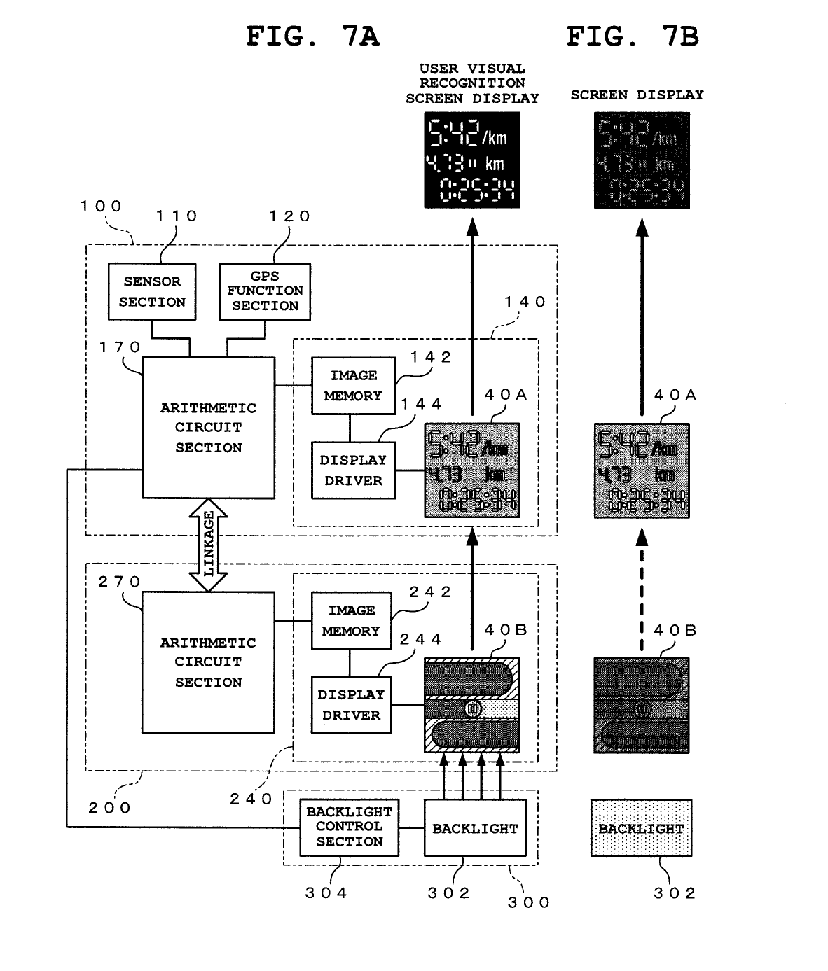

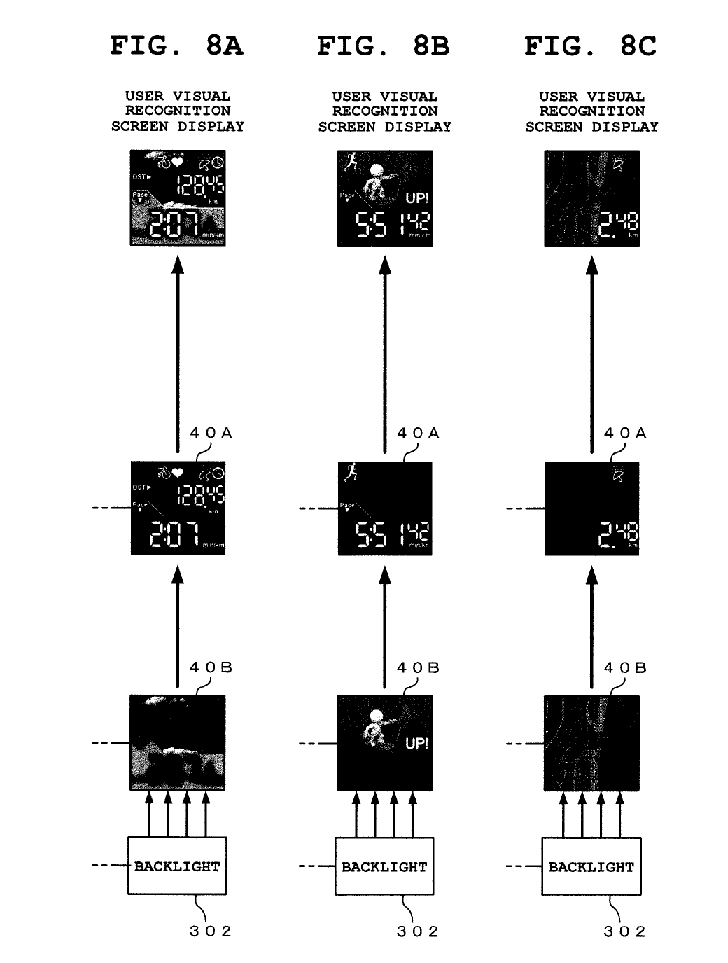

FIG. 4 is a schematic diagram showing an example of a first display mode of screen display by the electronic device according to the embodiment, and FIG. 5A, FIG. 5B and FIG. 6A to FIG. 6C are schematic diagrams showing a second display mode of screen display by the electronic device according to the embodiment. FIG. 7A, FIG. 7B, and FIG. 8A to FIG. 8C are schematic diagrams showing a third display mode of screen display by the electronic device according to the present embodiment.

(First Display Mode)

In the first display mode of the above-structured electronic device 10, the display section 140 is controlled such that, among the display panels 40A and 40B arranged to be overlapped with each other when viewed from the user's view field side as depicted in FIG. 1D, the display panel 40A on the field view side (an upper layer side in FIG. 1D) displays predetermined character information, image information, and the like, as depicted in FIG. 4.

That is, character information, image information, and the like generated by the arithmetic circuit section 170 of the internal circuit 100 and stored in the image memory 142 of the display section 140 are displayed on the display panel 40A by the display driver 144, as a simple monochrome image (a first image) of a reflective type with a segment, graphic, and the like and relatively high reflectivity. Also, an area of the display panel 40A where no character information, image information, and the like are being displayed is set in a transparent state.

On the other hand, the display section 240 is controlled such that no information is displayed on the display panel 40B on the back surface side (a lower layer side in FIG. 1D) of the display panel 40A. That is, at least the arithmetic circuit section 270 and the display section 240 (the image memory 242, the display driver 244, and the display panel 40B) of the internal circuit 20 are continuously and intermittently set in a non-operating state.

Here, the non-operating state in the arithmetic circuit section 270 and the display section 240 of the internal circuit 200 is controlled by the arithmetic circuit section 270 and the arithmetic circuit section 170 of the internal circuit 100 operating in conjunction with each other. Specifically, after transmitting a link signal for proceeding to the non-operating state without performing color display on the display panel 40B to the arithmetic circuit section 170 of the internal circuit 100, the arithmetic circuit section 270 saves or interrupts power supply to at least the display section 240 to proceed to the non-operating state. By receiving the above-mentioned link signal from the arithmetic circuit section 270, the arithmetic circuit section 170 displays the character information, image information, and the like on the display panel 40A as a monochrome image, sets an area of the display panel 40A where no character information, image information, and the like are being displayed in a transparent state, and continues this state.

Furthermore, by receiving the above-mentioned link signal from the arithmetic circuit section 270, the arithmetic circuit section 170 controls the backlight control section 304 of the light source section 300 such that the backlight 302 is turned OFF (switched OFF). As a result, the display panel 40B functions as a non-reflective layer arranged on the back surface side of the display panel 40A set in a semi-transparent state.

As described above, in the first display mode of the electronic device 10, character information, image information, and the like are displayed on the display panel 40A on the view field side (upper layer side) as a simple monochrome image of a reflective type with a segment, graphic, and the like and relatively high reflectivity. Also, an area of the display panel 40A where no character information, image information, and the like are being displayed is set in a transparent state. Furthermore, the display panel 40B on the back surface side (lower layer side) functions as a non-reflective layer, as depicted in FIG. 4.

As a result, the area of the display panel 40A where no character information, image information, and the like are being displayed appears to be black. Accordingly, the user can favorably visually recognize the character information, image information, and the like displayed on the display panel 40A, even outdoors or under a bright environment. Also, in the first display mode, when the display mode is being kept, the display section 140 of the internal circuit 100 is driven for display with low power consumption. Also, the arithmetic circuit section 270 and the display section 240 of the internal circuit 200 and the light source section 300 hardly consume power. Therefore, power consumption of the electronic device 10 can be significantly saved.

(Second Display Mode)

In the second display mode of the electronic device 10, the display section 140 is controlled such that no information is displayed on the display panel 40A on the user's view field side, as depicted in FIG. 5A and FIG. 5B. That is, at least the entire display area of the display panel 40A is set in a transparent state, and the image memory 142 and the display driver 144 of the display section 140 of the internal circuit 100 are continuously or intermittently set in a non-operating state.

Here, the non-operating state of the display section 140 of the internal circuit 100 is controlled by the arithmetic circuit section 170 and the arithmetic circuit section 270 of the internal circuit 200 operating in conjunction with each other. Specifically, the arithmetic circuit section 170 sets the arithmetic circuit section 270 such that no information is displayed on the display panel 40A and the entire display area is set in a transparent state, transmits a link signal for causing the display section 140 to proceed to a non-operating state, saves power supply to at least the display section 140, and proceeds to the non-operating state.

On the other hand, by receiving the above-mentioned link signal from the arithmetic circuit section 170, the arithmetic circuit section 270 controls the display section 240 such that predetermined character information, image information, and the like are displayed on the display panel 40B on the back surface side of the display panel 40A. That is, character information, image information, and the like generated by the arithmetic circuit section 270 and stored in the image memory 242 of the display section 240 are displayed on the display panel 40B by the display driver 244, as a high-definition color image (a second image) with rich color representation and visual effects.

Furthermore, based on at least the user's intentional motion for visually recognizing screen display by the electronic device 10, the arithmetic circuit section 170 controls the backlight control section 304 of the light source section 300 such that the backlight 302 is turned ON (switched ON) or turned OFF (switched OFF).

Specifically, if sensor data acquired by the sensor section 110 or an operation signal or the like (a specific state) from the input operating section 130 in relation to the user's intentional motion when the user visually recognizes screen display is detected, the arithmetic circuit section 170 controls the backlight control section 304 of the light source section 300 such that the backlight 302 is turned ON (switched ON), with predetermined character information, image information, and the like being displayed by color display in advance on the display panel 40B, as depicted in FIG. 5A.

Alternatively, when the above-described sensor data, operation signal, or the like is detected, the arithmetic circuit section 170 transmits a predetermined link signal to the arithmetic circuit section 270 to control the display section 240 such that predetermined character information, image information, and the like are displayed by color display on the display panel 40B and to control such that the backlight 302 of the light source section 300 is turned ON (switched ON), as depicted in FIG. 5A. As a result, the display panel 40B on the back surface side of the display panel 40A is illuminated with light, and the character information, image information, and the like displayed by color display on the display panel 40B are visually recognized by the user as a rich color image via (as passing through) the display panel 40A set in the full-transparent state.

On the other hand, when the user's intentional visual recognition motion has not been detected, the arithmetic circuit section 170 controls at least the backlight control section 304 such that the backlight 302 is turned OFF (switched OFF), as depicted in FIG. 5B. Alternatively, when the user's intentional visual recognition motion has not been detected, the arithmetic circuit section 170 transmits a predetermined link signal to the arithmetic circuit section 270 to control the display section 240 such that no color image is displayed on the display panel 40B and to control such that the backlight 302 is turned OFF (switched OFF).

As described above, in the second display of the electronic device 10, the display panel 40A is set in a full-transparent state, and character information, image information, and the like are displayed as a rich color image on the display panel 40B on the back surface side (lower layer side) of the display panel 40A, as depicted in FIG. 5A and FIG. 5B.

Then, only when the user's intentional motion for visually recognizing screen display of the electronic device 10 is made, the display panel 40B is illuminated by the light of the backlight 302, whereby the user can visually recognize the character information, image information, and the like displayed on the display panel 40B as a rich color image via the display panel 40A set in the full-transparent state.

Also, in the second display mode, when this display status is being kept, the display section 140 of the internal circuit 100 is driven for display with low power consumption. In addition, when the user has not made an intentional visual recognition motion, at least the light source section 300 does not consume power. Therefore, the power consumption of the electronic device 10 can be significantly saved. In FIG. 5A and FIG. 5B, character information is displayed on the display panel 40B by color display, as screen display to be visually recognized by the user. However, arbitrary image information including character information may be displayed as a rich color image on the display panel 40B, as depicted in FIG. 6A to FIG. 6C.

FIG. 6A and FIG. 6C are schematic diagrams depicting a state in which arbitrary image information is being displayed on the display panel 40B by color display and the backlight 302 is ON (switched ON). FIG. 6B is a schematic diagram depicting a state in which the backlight 302 is OFF (switched OFF) in the display mode depicted in FIG. 6A,

(Third Display Mode)

In the third display mode of the electronic device 10, the display section 140 is controlled such that predetermined character information, image information, and the like are displayed on the display panel 40A on the user's view field side, as depicted in FIGS. 7A and 7B. That is, character information, image information, and the like generated by the arithmetic circuit section 170 and stored in the image memory 142 of the display section 140 are displayed on the display panel 40A by the display driver 144, as a simple monochrome image of a reflective type with a segment, graphic, and the like and relatively high reflectivity. Also, an area of the display panel 40A where no character information, image information, and the like are being displayed is set in a transparent state.

Here, the display status of the display section 140 of the internal circuit 100 is controlled by the arithmetic circuit section 170 and the arithmetic circuit section 270 of the internal circuit 200 operating in conjunction with each other. Specifically, to the arithmetic circuit section 270, the arithmetic circuit section 170 transmits a link signal regarding a monochrome image to be displayed on the display panel 40A, its display timing and display mode, and the like.

On the other hand, by receiving the above-mentioned link signal from the arithmetic circuit section 170, the arithmetic circuit section 270 controls the display section 240 such that predetermined character information, image information, and the like linked with the monochrome image displayed on the display panel 40A are displayed on the display panel 40B on the back surface side of the display panel 40A at predetermined timing. Here, the display status of the display section 240 of the internal circuit 200 is controlled by the arithmetic circuit section 170 of the internal circuit 100 and the arithmetic circuit section 270 operating in conjunction with each other.

That is, character information, image information, and the like generated by the arithmetic circuit section 270 and stored in the image memory 242 are displayed by the display driver 244 on the display panel 40B as a rich color image. In addition, by the arithmetic circuit section 270 and the arithmetic circuit section 170 operating in conjunction with each other, the color image is displayed with it being superimposed on a simple monochrome image displayed on the display panel 40A.

Here, the color image displayed on the display panel 40B may be used as a background image or ornamental image of the monochrome image displayed on the display panel 40A with a segment, graphic, and the like, as depicted in FIG. 7A and FIG. 8A. Also, the color image may represent information related to the information represented by the monochrome image displayed on the display panel 40A, or may represent information of a totally different type.

For example, for a monochrome image displayed on the display panel 40A and indicating numerical value information such as a pace and lap time, a color image indicating support information based on results of analyzing the pace, lap time, and the like (for example, an image prompting the user to increase the pace) may be displayed on the display panel 40B, as depicted in FIG. 8B. Alternatively, for a monochrome image displayed on the display panel 40A and indicating numerical information such as a traveling distance, a color image (map) indicating the current position, traveling path, and the like of the user may be displayed on the display panel 40B, as depicted in FIG. 8C.

As described above, in the present embodiment, by the arithmetic circuit section 170 and the arithmetic circuit section 270 being linked and synchronized with each other and operated, a monochrome image displayed on the display panel 40A and a color image displayed on the display panel 40B are superimposed on each other to achieve various display modes.

In order to achieve these various display modes, the arithmetic circuit section 170 and the arithmetic circuit section 270 are each required to grasp at least its “current operation status”, “information being displayed”, “information display mode”, and the like and operate in a synchronized manner. Accordingly, a link signal transmitted between the arithmetic circuit section 170 and the arithmetic circuit section 270 contains at least these pieces of information, and is transmitted and received continuously or at predetermined timing as necessary.

Furthermore, as with the above-described second display mode, the arithmetic circuit section 170 performs control such that the backlight 302 of the light source section 300 is turned ON (switched ON) or turned OFF (switched OFF) based on at least the user's intentional motion to visually recognize screen display by the electronic device 10.

When sensor data, an operation signal, or the like related to an intentional motion when the user visually recognizes screen display is detected, the arithmetic circuit section 170 causes predetermined character information, image information, and the like to be displayed in advance on the display panel 40A by monochrome display, as depicted in FIG. 7A. In addition, with character information, image information, and the like to be linked being displayed on the display panel 40B by color display, the arithmetic circuit section 170 performs control such that the backlight 302 is turned ON (switched ON).

Alternatively, when the above-described sensor data, operation signal, or the like is detected, the arithmetic circuit section 170 causes predetermined character information, image information, and the like to be displayed on the display panel 40A by monochrome display, as depicted in FIG. 7A. In addition, the arithmetic circuit section 170 transmits a predetermined link signal to the arithmetic circuit section 270 to control the display section 240 such that character information, image information, and the like to be linked are displayed on the display panel 40B by color display and the backlight 302 of the light source section 300 is turned ON (switched ON).

As a result, the display panel 40B is illuminated with light from the backlight 302, and an image (hereinafter referred to as a “superimposed image” for convenience of explanation) acquired by superimposing or combining the simple monochrome image displayed on the display panel 40A and having relatively high reflectivity and the rich color image displayed on the display panel 40B is visually recognized by the user.

On the other hand, when the user's intentional visual recognition motion has not been detected, the arithmetic circuit section 170 performs control such that the backlight 302 is turned OFF (switched OFF) as depicted in FIG. 7B, as with the above-described second display mode. Alternatively, when the user's intentional visual recognition motion has not been detected, the arithmetic circuit section 170 transmits a predetermined link signal to the arithmetic circuit section 270 to control the display section 240 such that no color image is displayed on the display panel 40B and the backlight 302 is turned OFF (switched OFF).

As described above, in the third display mode of the electronic device 10, a simple monochrome image of a reflective type with a segment, graphic, and the like is displayed on the display panel 40A with relatively high reflectivity, and also a rich color image linked with the monochrome image is displayed on the display panel 40B at predetermined timing, as depicted in FIG. 7A and FIG. 7B.

Then, only when the user's intentional motion for visually recognizing screen display of the electronic device 10 is made, the display panel 40B is illuminated with the light of the backlight 302, whereby the user can visually recognize a superimposed image acquired by superimposing the monochrome image displayed on the display panel 40A and the color image displayed on the display panel 40B. Here, even outdoors or under a bright environment, the user can favorably visually recognize the character information, image information, and the like displayed on the display panel 40A that performs display using at least reflection of external light, as a highly-contrasted monochrome image. At the same time, the user can visually recognize the character information, image information, and the like displayed on the display panel 40B as a rich color image via the display panel 40A set in a semi-transparent state.

Also, in the third display mode, when this display status is being kept, the display section 140 of the internal circuit 100 is driven for display with low power consumption. In addition, when the user has not made an intentional visual recognition motion, at least the light source section 300 does not consume power. Therefore, the power consumption of the electronic device 10 can be significantly saved.

<Electronic Device Control Method>

Next, an electronic device control method (information display method) according to the present embodiment is described. Here, the control method is described using a case where a user wears the electronic device 10 having a wristwatch-like or wristband-like appearance depicted in FIG. 1A on his or her wrist to record various data in a running exercise or a walking exercise or in daily life, and various information is displayed on the display panel 40 and provided to the user. Here, a series of processing operations described below are achieved by a predetermined algorithm program being executed by the arithmetic circuit section 170 of the internal circuit 100 and the arithmetic circuit section 270 of the internal circuit 200.

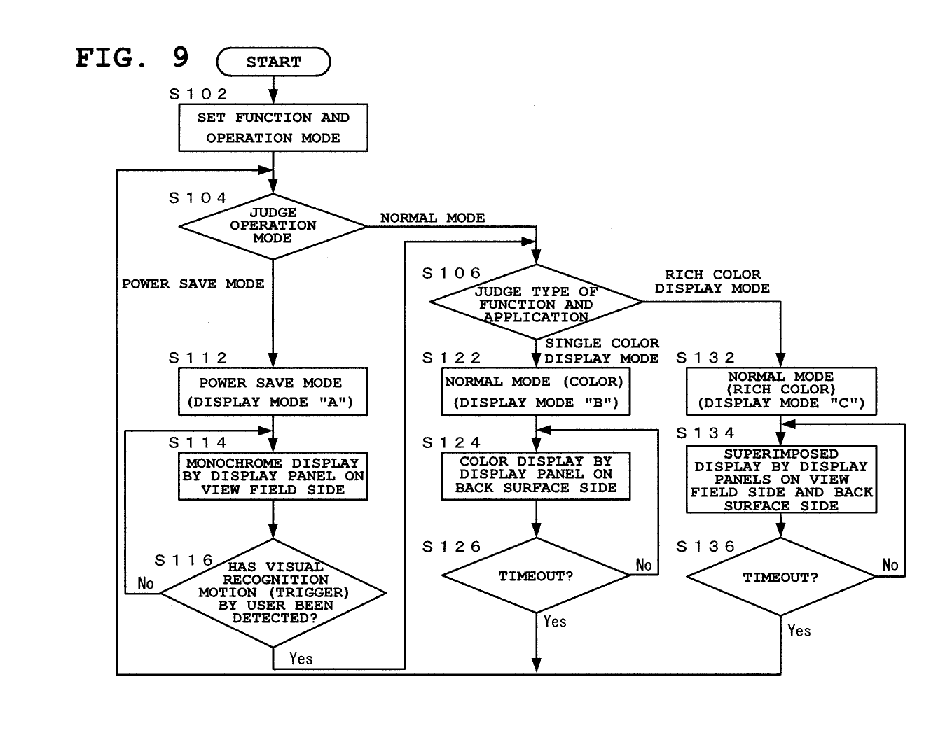

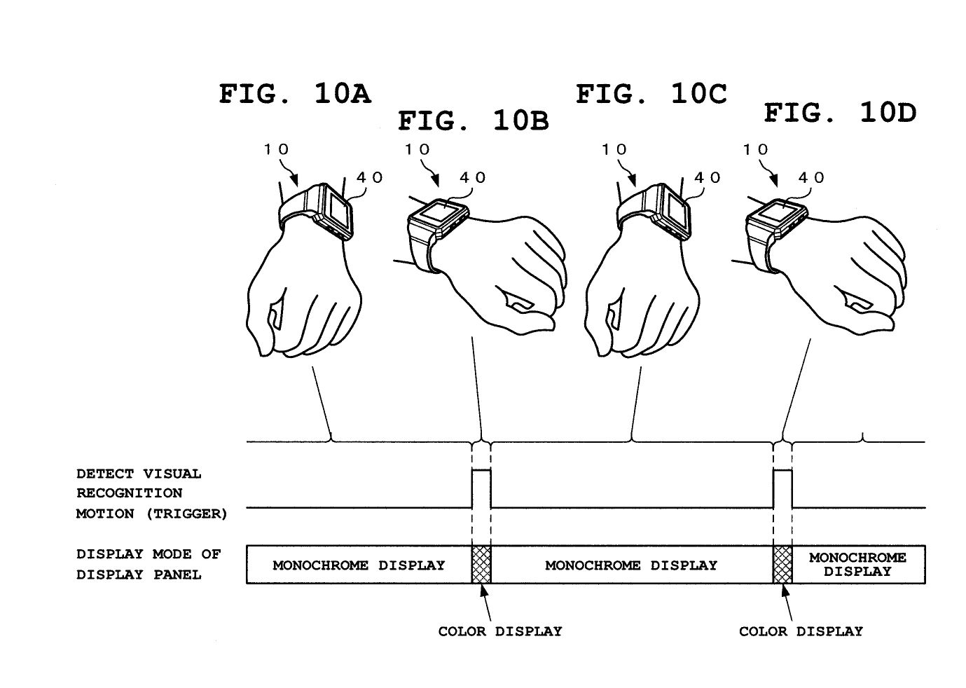

FIG. 9 is a flowchart of an example of the electronic device control method according to the present embodiment. FIG. 10 is a schematic diagram showing an example of a method for detecting a user's visual recognition motion in the electronic device control method according to the present embodiment. Here, description is made with reference to each of the above-described display modes (refer to FIG. 4A to FIG. 8C) as appropriate.

In the electronic device control method according to the present embodiment, for example, for the electronic device 10 worn (or to be worn) on a wrist of the user, the user first sets a function and application (software) to be performed, and sets an operation mode regarding power consumption (Step S102), as depicted in the flowchart of FIG. 9. Specifically, by the user operating the input operating section 130 such as a button switch or a slide switch provided on the housing of the electronic device 10 or the input operating section 230 such as a touch panel arranged on the view field side of the display panel 40A, one of a plurality of operation modes which define the power consumption of the electronic device 10 is set in the arithmetic circuit sections 170 and 270.

As a result, the arithmetic circuit section 170 of the internal circuit 100 and the arithmetic circuit section 270 of the internal circuit 200 are operated in conjunction with each other, perform communication continuously or at predetermined timing as appropriate, and transmit and receive a link signal regarding the set operation mode. Here, in the present embodiment, as the operation modes of the electronic device 10, “power save mode” and “normal mode” are provided in advance, and one of these operation modes is selected and set by the user. In the “power save mode”, various functional operations are performed while saving the power consumption of the electronic device 10. In the “normal mode”, various functional operations are performed placing emphasis on performance (such as processing speed and appearance of screen display).

Next, the arithmetic circuit section 170 judges the operation mode set at Step S102 (Step S104), and controls the display mode of screen display by the display panel 40 based on the judgment result. Specifically, the arithmetic circuit section 170 first judges whether the operation mode set by the user is the power save mode or the normal mode.

When judged that the set operation mode is the power save mode, the arithmetic circuit section 170 applies display mode “A”, and performs control such that character information, image information, and the like in accordance with the set function and application are displayed on the display panel 40 with low power consumption (Step S112). Here, in display mode “A”, screen display is performed which is achieved by a combination of a state where a monochrome image with a segment, graphic, and the like is being displayed on the display panel 40A on the view field side in a semi-transparent state and a state where nothing is being displayed on the display panel 40B on the back surface side and the display panel 40B is functioning as a non-reflective layer, as depicted in the above-mentioned first display mode (refer to FIG. 4).

That is, in display mode “A” applied to the power save mode, the character information, image information, and the like are singly displayed on the display panel 40A on the view field side as a simple monochrome image of a reflective type with relatively high reflectivity (Step S114). This screen display with the monochrome image is updated at predetermined time intervals.

Then, the arithmetic circuit section 170 monitors, continuously or at predetermined intervals, whether the user's intentional visual recognition motion (trigger) has been detected during the operation of the screen display in the power save mode (Step S116) Specifically, when sensor data acquired by the sensor section 110 or an operation signal from the input operating section 130 is detected which is related to an intentional motion by the user when the user visually recognizes the screen display by the display panel 40 of the electronic device 10, the arithmetic circuit section 170 performs processing operations at Step S106 and the following steps described later, and thereby performs color display in a predetermined form.

Here, events that are detected as the user's intentional visual recognition motion include a press operation on the button switch, a touch operation on the touch panel, the detection of an output unique to a visual recognition motion by the acceleration sensor or the gyro sensor, the detection of a specific gesture or shock (such as impact) defined in advance by the acceleration sensor or the like, and the inputting of a specific voice command from the microphone. More specifically, for example, when the user lifts the arm wearing the electronic device 10 within the range of the view field to see the screen display by the display panel 40 and a specific signal, waveform, or the like outputted from the acceleration sensor or the gyro sensor is detected, the arithmetic circuit section 170 judges that the user has made an intentional visual recognition motion, as depicted in FIG. 10B and FIG. 10D.

On the other hand, when the user's intentional visual recognition motion has not been detected, the arithmetic circuit section 170 continues the simple monochrome display with relatively high reflectivity in display mode “A”. That is, for example, when the user unintentionally moves down or swings the arm wearing the electronic device 10 as depicted in FIG. 10A and FIG. 10C, the arithmetic circuit section 170 judges that the user is not watching the screen display by the display panel 40 (the user is not making a visual recognition motion) based on a signal, waveform, or the like outputted from the acceleration sensor or the gyro sensor. In this case, the arithmetic circuit section 170 keeps the power save mode to continue the screen display in display mode “A” for driving and displaying with low power consumption.

In the processing of judging the operation mode (Step S104), when the operation mode is the normal mode or when the user's intentional visual recognition motion (trigger) is detected at Step S116, the arithmetic circuit section 170 judges the type of a set function, application, and the like to be executed by the electronic device 10 (Step S106), and controls the display mode of the screen display by the display panel 40 based on the judgment result.

Specifically, the arithmetic circuit section 170 first judges whether the type of the function, application, and the like is suitable for a display mode in which predetermined character information, image information, and the like are displayed as a single color image (hereinafter referred to as a “single color display mode”) or is suitable for a display mode in which predetermined character information, image information, and the like are displayed as a superimposed image acquired by superimposing or combining a monochrome image and a color image (hereinafter referred to as a “rich color display mode”).

Here, the types of the functions, applications, and the like may be set in advance according to the display modes of screen display by the display panel 40. Then, when the type of the function, application, and the like is suitable for the single color display mode, the arithmetic circuit section 170 applies display mode “B” to drive and display while saving the power consumption of the display panel 40 (Step S122).

Here, in display mode “B”, screen display is performed which is achieved by a combination of the full-transparent state in which nothing is displayed on the display panel 40A on the view field side and the state in which a color image is displayed on the display panel 40B on the back surface side, as in the second display mode (refer to FIG. 5A to FIG. 6C). That is, in display mode “B” applied to the normal mode, the character information, image information, and the like are singly displayed as a rich color image on the display panel 40B on the back surface side, by passing through the display panel 40A in the full-transparent state (Step S124). This screen display with the color image is updated at predetermined time intervals.

Then, the arithmetic circuit section 170 monitors whether the screen display with the normal color image has passed a time limit set in advance (whether a timeout occurs) (Step S126). Here, the time limit may be arbitrarily set by the user or may have a default value set in advance. The arithmetic circuit section 170 transmits a link signal to the arithmetic circuit section 270 of the internal circuit 200 so that the screen display with the normal color image is continued until the above-mentioned time limit is reached. On the other hand, when the screen display with the normal color image reaches the time limit, the arithmetic circuit section 170 returns to Step S104 and performs the above-described series of processing operations again.

On the other hand, in the processing of judging the type of the function, application, and the like to be executed by the electronic device 10 (Step S106), when the function, application, and the like are suitable for the rich color display mode, the arithmetic circuit section 170 applies display mode “C” and drives the display panel 40 for display such that the highly-contrasted monochrome image and the rich color image are superimposed on each other for display (superimposed display) (Step S132).

Here, in display mode “C”, screen display is performed by superimposing or combining the state where a monochrome image is displayed with a segment, graphic, and the like in a semi-transparent state on the display panel 40A on the view field side and the state where a color image is displayed on the display panel 40B on the back surface side (Step S134), as in the third display mode (refer to FIG. 7A to FIG. 8C). That is, in display mode “C” applied to the normal mode, the simple monochrome image with a segment, graphic, and the like displayed with relatively high reflectivity on the display panel 40A on the view field side and the rich color image displayed on the display panel 40B on the back surface side are displayed by being superimposed on each other. This screen display with the superimposed image is updated at predetermined time intervals.

Then, the arithmetic circuit section 170 monitors whether the screen display with the superimposed image has passed a time limit set in advance (whether a timeout occurs) (Step S136). Here, the arithmetic circuit section 170 transmits a link signal to the arithmetic circuit section 270 so that the screen display with the superimposed image continues until the time limit is reached. On the other hand, when the screen display with the superimposed image reaches the time limit, the arithmetic circuit section 170 returns to Step S104 and performs the above-described series of processing operations again.

Note that, although not depicted in the flowchart of FIG. 9, the arithmetic circuit sections 170 and 270 continuously monitor an operation for interrupting or ending the processing operations and a change of the state while performing the above-described series of processing operations. Then, when an interrupting or ending operation or a change of the state is detected, the arithmetic circuit sections 170 and 270 forcibly end the processing operations. Specifically, when an OFF (power supply shutoff) operation on the power supply switch of the electronic device 10 by the user, a reduction in the remaining amount of the battery in the power supply section 400, an anomaly in the function or application being executed, or the like is detected, the arithmetic circuit sections 170 and 270 forcibly interrupt and end the series of processing operations.

As described above, in the present embodiment, when the current operation mode of the electronic device 10 is the power save mode, a simple monochrome image with a segment, graphic, and the like is displayed on the display panel 40 with relatively high reflectivity. Then, only when an intentional motion of visually recognizing screen display by the display panel 40 is made by the user wearing the electronic device 10, the operation mode is changed from the power save mode to the normal mode (that is, the display mode is changed), and a color display is performed in a predetermined display mode. In the normal mode, rich color display with a single color image or display with a superimposed image of a highly-contrasted monochrome image and a rich color image is performed in accordance with the type of a function, application, and the like to be executed in the electronic device 10.

Accordingly, in the present embodiment, when the user is not wearing the electronic device or not visually recognizing screen display by the electronic device, highly-contrasted monochrome display is performed with low power consumption. Then, only when an intentional motion of visually recognizing screen display by the electronic device is made by the user, color display is performed in a predetermined form. As a result of this configuration, it is possible to provide desired information by color display in various display modes while saving power consumption to improve driving time.

Also, in the present embodiment, the display mode of color display is controlled in accordance with the type of a function, application, and the like to be executed in the electronic device 10. Therefore, screen display with a superimposed image is achieved only for a specific function, application, and the like, and normal color display is performed for other functions, applications, and the like, whereby power consumption is saved.

Here, operations and effects of the present embodiment are specifically examined. In general, a portable electronic device including a display device capable of color display has a display section including a single color liquid-crystal display panel and a single arithmetic circuit (processor). In this electronic device, in order to display various information as a high-definition rich color image with excellent color representation and visual effects or to transfer a large amount of data to the display section, an external device, and the like, an arithmetic circuit with high arithmetic processing performance and high power consumption, such as the arithmetic circuit section 270 in the present embodiment, is required to be adopted. Also, since this arithmetic circuit is required to be always driven to perform various functions, applications, and the like in addition to the time of providing various information to the user, the power consumption is significantly large. Accordingly, the driving time of the battery-driven portable electronic device is shortened significantly.

By contrast, in structure of the present embodiment, the display panel 40A capable of monochrome display with low power consumption and the display panel 40B capable of rich color display are provided and these display panels 40A and 40B are controlled by the arithmetic circuit sections 170 and 270, respectively, which are independent from each other and each of which has a processing power in accordance with each display mode. By these arithmetic circuit sections 170 and 270 being linked and synchronized with each other to set the display panel 40B for color display and the arithmetic circuit section 270 in a non-operating state during a period other than a period of the user's visual recognition motion, power consumption in the electronic device 10 can be significantly saved to improve the driving time.

Also, in structure of the present embodiment, the display panel 40A capable of monochrome display with relatively high reflectivity and the display panel 40B capable of rich color display are superimposed on each other such that they are overlapped with each when viewed from the field view side. In addition, the arithmetic circuit sections 170 and 270 are linked and synchronized with each other to control the display status of these display panels 40A and 40B. Accordingly, it is possible to provide desired information in various display modes with excellent viewability while saving power consumption.

In the above-described embodiment, the user sets an arbitrary operation mode (the power save mode and the normal mode) of the electronic device 10 in the processing for setting the operation mode of the electronic device 10 (Step S102). However, the present invention is not limited thereto.

For example, the power save mode may be automatically set as a default (initial setting) without the operation mode being set by the user. As a result, highly-contrasted monochrome display with low power consumption is automatically performed in an initial state. Then, only when a screen display visual recognition motion by the user is detected, the current operation mode is changed to the normal mode, and rich color display or display with a superimposed image of a monochrome image and a color image is performed in accordance with the type of a function, application, and the like to be executed. Then, after the end of the function, the application, and the like, the operation mode is again changed to the power save mode for highly-contrasted monochrome display with low power consumption. Therefore, it is possible to provide desired information in various display modes with excellent viewability while saving power consumption.

Also, in the above-described embodiment, the power save mode and the normal mode are provided in advance as operation modes of the electronic device 10 and one of these operation modes is selected by the user. However, the present invention is not limited thereto, and a configuration may be adopted in which another operation mode can be selected.

Moreover, in the above-described embodiment, an operation mode regarding power consumption of the electronic device 10 (the power save mode or the normal mode) is set by the user. However, the present invention is not limited thereto, and a configuration may be adopted in which the user directly sets the display mode of the display panel 40 of the electronic device 10.

For example, a configuration may be adopted in which, as display modes, an eco mode corresponding to the above-described display mode “A” (the first display mode; refer to FIG. 4), a color mode corresponding to display mode “B” (the second display mode; refer to FIG. 5A to FIG. 6C), and a combination mode corresponding to display mode “C” (the third display mode; refer to FIG. 7A to FIG. 8C) are provided in advance, the user selects and sets one of these display modes, and the selected display mode is changed to another display mode when a screen display visual recognition motion by the user is detected. In this configuration as well, a processing procedure equivalent to that of the above-described embodiment (FIG. 9) can be adopted so as to provide desired information in various display modes with excellent viewability while saving power consumption. Note that display mode “C” that is the combination mode is not necessarily required. Only by switching between the display mode A and the display mode B, excellent viewability and reduction in power consumption can be achieved.

Moreover, in the above-described embodiment, as the display panel 40, the display area of the display panel 40A for monochrome display and the display area of the display panel 40B for color display are superimposed on each other such that they are completely or substantially completely overlapped with each other when viewed from the view field side. However, the present invention is not limited thereto. The display panel 40 applied in the present invention may have a structure where a plurality of display panels have been arranged such that their display areas are partially overlapped with each other when viewed from the view field side. In this structure as well, by applying a processing procedure equivalent to that of the above-described embodiment (FIG. 9), it is possible to provide desired information in various forms with excellent viewability while saving power consumption.

Furthermore, in the above-described embodiment, a PN liquid-crystal panel is applied as the display panel 40A on the view field side forming the display panel 40. However, the present invention is not limited thererto. The display panel 40A applied in the present invention may be any display panel with low power consumption which is capable of reflective-type display with relatively high reflectivity and excellent outdoor visual recognition and capable of semi-transparent display and full-transparent display. For example, a display panel made of PDLC (Polymer Dispersed Liquid Crystal) or the like may be adopted. Also, the display panel 40B forming the display panel 40 is not limited to a TFT color liquid-crystal panel. This display panel 40B applied in the present invention may be any display panel capable of high-definition color display with rich color representation and visual effects. For example, an organic EL (Electroluminescence) panel structured to have self-luminous elements two-dimensionally arranged thereon may be adopted. In this case, a structure excluding the light source section 300 can be applied to the above-described electronic device 10 (refer to FIG. 2 and FIG. 3).

Still further, in the above-described embodiment, the electronic device 10 is any one of a sports watch or smartwatch having an outer appearance of a wristwatch or wristband type which is worn on the body of the user; a smartphone or portable telephone that is used by being held by user's hand; and a portable device for use outdoors by the user at mountaineering or the like. However, for example, the electronic device 10 may be the device body section of a digital camera having a photographing section which photographs an image and a display section which displays a photographed image. In this case, for example, the device body section is connected to the photographing section, and control is performed such that a camera icon is displayed by monochrome display on the display panel 40A and display by the display panel 40B is not performed when the photographing section is not performing image photographing, and color display by the display panel 40B is performed only when the photographing section is performing image photographing or when the photographed result is displayed. Also, further control may be performed such that color display by the display panel 40B is performed or the backlight 302 is turned ON only when the photographing section is performing image photographing or when the photographed result is displayed and the user makes an intentional motion of visually recognizing the image on the display section.

While the present invention has been described with reference to the preferred embodiments, it is intended that the invention be not limited by any of the details of the description therein but includes all the embodiments which fall within the scope of the appended claims.

What is claimed is:

1. A display device comprising:
a first display panel having a first display area;
a second display panel having a second display area;
an arithmetic circuit which controls a display status of the first display panel and a display status of the second display panel; and
a sensor which detects a spatial movement of the display device,
wherein the arithmetic circuit changes a display mode of images displayed by the first display panel and the second display panel based on a detection result by the sensor.

2. The display device according to claim 1, wherein the arithmetic circuit includes a first arithmetic circuit which controls the display status of the first display panel, and a second arithmetic circuit which controls the display status of the second display panel by operating in conjunction with the first arithmetic circuit.

3. The display device according to claim 1, wherein the first display area of the first display panel and the second display area of the second display panel are arranged such that the first display area and the second display area are at least partially overlapped with each other when viewed from a view field side of a user.

4. The display device according to claim 2, wherein the display mode includes a first display mode in which only a first image is displayed by the first display panel and a second display mode in which only a second display image is displayed by the second display panel.

5. The display device according to claim 4, wherein the display mode further includes a third display mode in which a third image acquired by the first image of the first display panel and the second image of the second display panel being superimposed on each other is displayed.

6. The display device according to claim 4, wherein the arithmetic circuit sets the display mode to the first display mode when a specific movement corresponding to an intentional motion by a user with respect to the first display panel and the second display panel is not detected by the sensor, and sets the display mode to the second display mode when the specific movement is detected by the sensor.

7. The display device according to claim 5, wherein the first arithmetic circuit and the second arithmetic circuit set the display mode to the first display mode when a specific movement corresponding to an intentional motion by a user with respect to the first display panel and the second display panel is not detected by the sensor, and set the display mode to the third display mode when the specific movement is detected by the sensor.

8. The display device according to claim 4, wherein the second arithmetic circuit is set in a non-operating state when the display mode is set to the first display mode.

9. The display device according to claim 5, wherein the first display area of the first display panel is arranged on a view field side of a user with respect to the second display area of the second display panel,
wherein the arithmetic circuit in the first display mode controls such that the first image is displayed in the first display area of the first display panel and no image is displayed in the second display area of the second display panel,
wherein the arithmetic circuit in the second display mode controls such that the first display area of the first display panel is entirely set in a transparent state and the second image is displayed in the second display area of the second display panel, and
wherein the arithmetic circuit in the third display mode controls such that the first image is displayed in the first display area of the first display panel, an area of the first display area where the first image is not displayed is set in the transparent state, and the second image is displayed in the second display area of the second display panel.

10. The display device according to claim 2, wherein the sensor is controlled by the first arithmetic circuit.

11. The display device according to claim 2, wherein power consumption when the first display panel and the first arithmetic circuit are operating is lower than power consumption when the second display panel and the second arithmetic circuit are operating.

12. The display device according to claim 1, wherein the first display panel has a function of displaying an image in monochrome by reflecting external light, and
wherein the second display panel has a function of displaying an image in color.

13. The display device according to claim 1, further comprising:
a housing which accommodates the first display panel having the first display area, the second display panel having the second display area, the arithmetic circuit which controls the display status of the first display panel and the display status of the second display panel, and the sensor which detects a spatial movement of the display device.

14. A display device control method comprising:
a step of displaying, on a display section including a first display panel having a first display area and a second display panel having a second display area arranged to be at least partially overlapped with the first display area when viewed from a view field side of a user, a display image acquired by a display status of the first display panel being combined with a display status of the second display panel;
a step of detecting a spatial movement of the first display panel and the second display panel; and
a step of changing a display mode of the image displayed by the first display panel and the second display panel based on a result of the detection.

15. A non-transitory computer-readable storage medium having a display device control program stored thereon that is executable by a computer to actualize functions comprising:
processing for displaying, on a display section including a first display panel having a first display area and a second display panel having a second display area arranged to be at least partially overlapped with the first display area when viewed from a view field side of a user, a display image acquired by a display status of the first display panel being combined with a display status of the second display panel;
processing for detecting a spatial movement of the first display panel and the second display panel; and
processing for changing a display mode of the image displayed by the first display panel and the second display panel based on a result of the detection.
